(19) United States
(12) Patent Application Publication
(10) Pub. No.: US 2025/0353551 A1
(43) Pub. Date: Nov. 20, 2025

(54) FRAME MEMBER FOR VEHICLE

(71) Applicant: MAZDA MOTOR CORPORATION, Hiroshima (JP)

(72) Inventors: Yui KUROKI, Aki-gun (JP); Daisuke KANAMARU, Aki-gun (JP); Nobutaka TANIGUCHI, Aki-gun (JP)

(73) Assignee: MAZDA MOTOR CORPORATION, Hiroshima (JP)

(21) Appl. No.: 19/081,910

(22) Filed: Mar. 17, 2025

(30) Foreign Application Priority Data
May 14, 2024 (JP) 2024-078782

(51) Int. Cl. B62D 21/15

(52) U.S. Cl. CPC B62D 21/155

(57) ABSTRACT

A frame member for a vehicle which extends in a longitudinal direction, comprises a frame body portion having a closed-cross section perpendicular to an extension direction thereof, the closed-cross section having plural vertexes, a pair of groove portions formed at a pair of side wall portions which form the closed-cross section of the frame body portion, the groove portions being recessed toward an inside of the closed-cross section, and plural flanges protruding outward from the closed-cross section. The closed-cross section is symmetrical about a point of center of gravity of the closed-cross section, including projection positions of the plural flanges, and is nonsymmetrical about all straight lines which pass through the center of gravity of the closed-cross section and are perpendicular to the longitudinal direction.

### BACKGROUND OF THE INVENTION

The present invention relates to a frame member for a vehicle.

Japanese Patent Laid-Open Publication No. 2009-166697 discloses a frame member for a vehicle which extends in a vehicle longitudinal direction and comprises an inner panel having a hat-shaped cross section perpendicular to an extension direction thereof which is open to an outward side, in a vehicle width direction, thereof and an outer panel having another hat-shaped cross section perpendicular to the extension direction which is open to an inward side, in the vehicle width direction, thereof, wherein respective upper-and-lower flanges of the inner panel and the outer panel are joined together in the vehicle width direction, thereby forming a close-cross section perpendicular to the extension direction of the frame member.

In the frame member for the vehicle of the above-described patent document, since the flanges are offset toward the outward side, in the vehicle width direction, thereof, the resistance against buckling of the outer panel is higher than that of the inner panel. Accordingly, when a collision load of the vehicle is applied from one side of the longitudinal direction, the inner panel tends to have the buckling easier than the outer panel. Consequently, when the collision load is applied, the frame member for the vehicle is not axially-compressed uniformly, so that the collision load cannot be absorbed expectedly.

### SUMMARY OF THE INVENTION

An object of the present invention is to provide a frame member for a vehicle which can properly absorb the collision load expectedly by its uniform axial compression when the collision load is applied.

The present invention is a frame member for a vehicle which extends in a longitudinal direction, comprising a frame body portion having a closed-cross section perpendicular to an extension direction thereof, the closed-cross section having plural vertexes, a pair of groove portions formed at a pair of side wall portions which form the closed-cross section of the frame body portion, the groove portions being recessed toward an inside of the closed-cross section, and plural flanges protruding outward from the closed-cross section, wherein the closed-cross section is symmetrical about a point of center of gravity of the closed-cross section, including projection positions of the plural flanges, and is nonsymmetrical about all straight lines which pass through the center of gravity of the closed-cross section and are perpendicular to the longitudinal direction.

According to the present invention, since the closed-cross section of the frame member for the vehicle is symmetrical about the point of center of gravity of the closed-cross section, including projection positions of the plural flanges, even in a case where the projection positions of the flanges to attach attaching members of a suspension housing and the like are located unevenly in the vehicle width direction, a difference, in the vehicle width direction, of the buckling resistance of the frame member against the load applied in the longitudinal direction can be suppressed. Consequently, when the collision load is applied, the frame member for the vehicle can be axially-compressed stably, thereby absorbing the collision load expectedly. Further, compared to a case where no groove portion is provided, the moment of inertia (of area) of the frame member is made so large that the buckling resistance can be properly large. Accordingly, by configuring the frame member such that the closed-cross section, including the groove portions, is symmetrical about the point of center of gravity of the closed-cross section, both an increase of the buckling resistance and a stable axial compression can be attained for the frame member for the vehicle.

As described above, the present invention can provide the frame member for the vehicle which can properly absorb the collision load expectedly by its uniform axial compression when the collision load is applied.

The present invention will become apparent from the following description which refers to the accompanying drawings.

### BRIEF DESCRIPTION OF THE DRAWINGS

FIG. 1 is a plan view of a front vehicle-body structure provided with a frame member for a vehicle according to an embodiment of the present invention.

FIG. 2 is a side view of the front vehicle-body structure.

FIG. 3 is a perspective view of the frame member for the vehicle alone.

FIG. 4 is a sectional view schematically showing a cross section of the frame member for the vehicle taken along line IV-IV of FIG. 3.

FIG. 5 is a sectional view of the frame member for the vehicle taken along line V-V of FIG. 3.

FIG. 6 is a sectional view schematically showing the cross section of the frame member for the vehicle taken along line VI-VI of FIG. 3.

FIG. 7 is a partially-enlarged view of a surrounding area of a suspension housing of the front vehicle-body structure.

FIG. 8 is a partially-enlarged view of a connecting member to connect the frame member for the vehicle and a subframe, and its surrounding area.

FIG. 9 is a sectional view schematically showing a cross section of a first modification of the frame member for the vehicle.

FIG. 10 is a sectional view schematically showing a cross section of a second modification of the frame member for the vehicle.

### DETAILED DESCRIPTION OF THE INVENTION

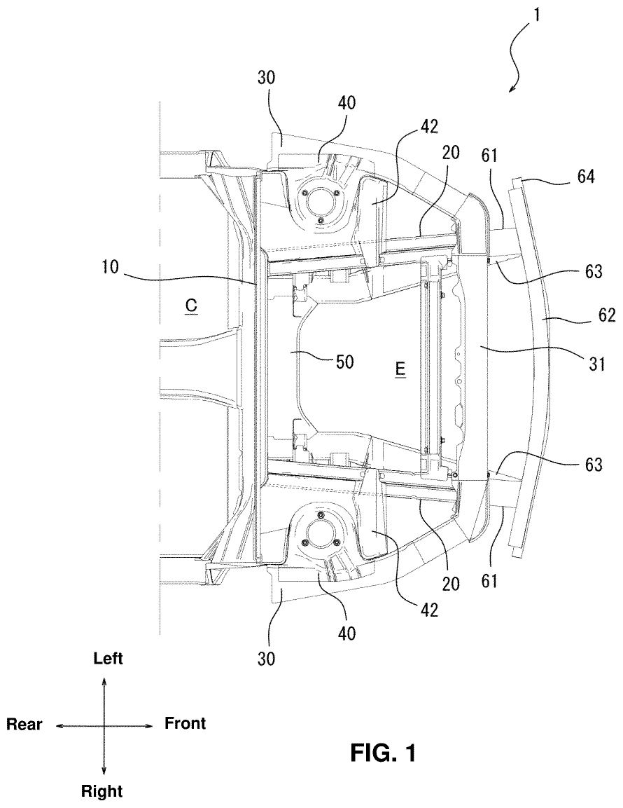

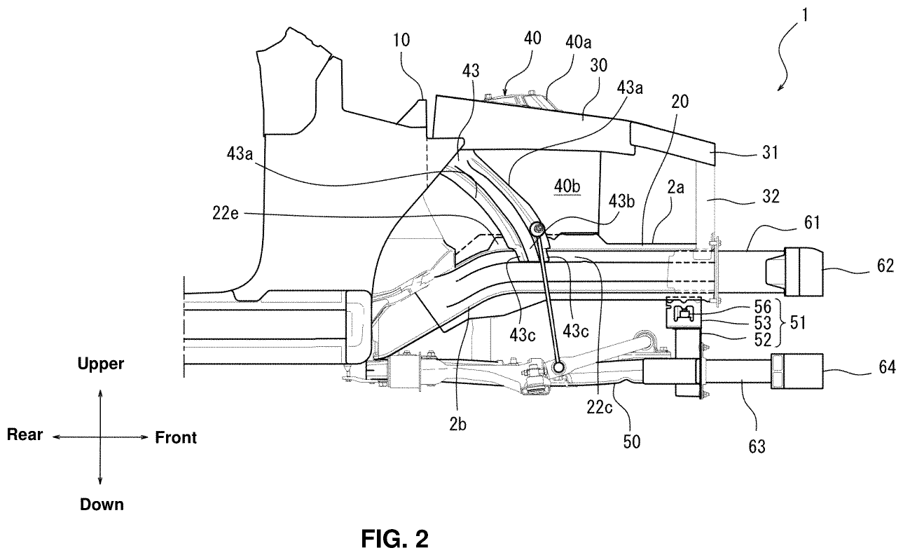

Hereafter, embodiments of the present invention will be described referring to the accompanying drawings. The following description is mealy exemplified embodiments, and therefore the present invention is not be limited in its applications or uses by those. FIGS. 1 and 2 show a front vehicle-body structure 1 of a vehicle which is provided with a frame member according to an embodiment of the present invention. As shown in FIGS. 1 and 2, the front vehicle-body structure 1 comprises a dash panel 10 which partitions a cabin C from an engine room E, a pair of right-and-left front side frames 20 which extend forward from the dash panel 10, and a pair of right-and-left apron reinforcements 30 which extend toward a front side of the dash panel 10 on an outward side, in a vehicle width direction, and above the front side frame 20. The apron reinforcement 30 is connected to a shroud upper 31 extending in the vehicle width direction.

The front vehicle-body structure 1 further comprises a pair of right-and-left shroud members 32 which connect the shroud upper 31 and respective front ends of the front side frames 20 in a vertical direction, a pair of right-and-left suspension housings 40 which are arranged between the dash panel 10 and the shroud members 32, a subframe 50 which is arranged below the front side frames 20, and a pair of right-and-left connecting members 51 which connect the subframe 50 and the front side frames 20 in the vertical direction.

A main crash can 61, which is made of a cylindrical member or the like to absorb a collision load applied from a vehicle forward side, extends forward at each front end of the front side frames 20. A pair of right-and-left main crash cans 61 are interconnected by a bumper reinforcement 62 which extends in the vehicle width direction. A sub crash can 63, which is made of another cylindrical member or the like to absorb the collision load applied from the vehicle forward side, extends forward at each front end of the subframe 50. A pair of right-and-left sub crash cans 63 are interconnected by a sub bumper reinforcement 64 which extends in the vehicle width direction.

As shown in FIG. 2, the front side frame 20 includes a straight portion 2a which forward extends roughly horizontally and an inclined portion 2b which extends obliquely downward-and-reward from a rear end of the straight portion 2a.

When the collision load is applied to the bumper reinforcement 62 from the vehicle forward side, the main crash can 61 and the front side frame 20 absorb part of the collision load and the rest of the collision load is dispersed to a rear-side vehicle-body frame.

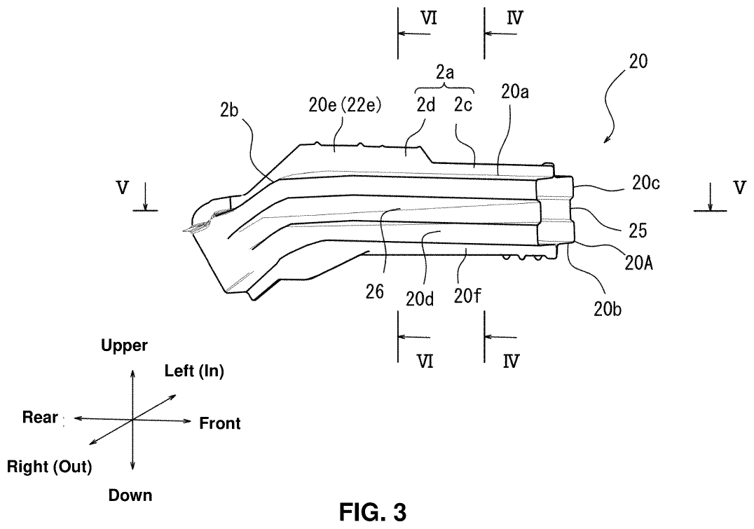

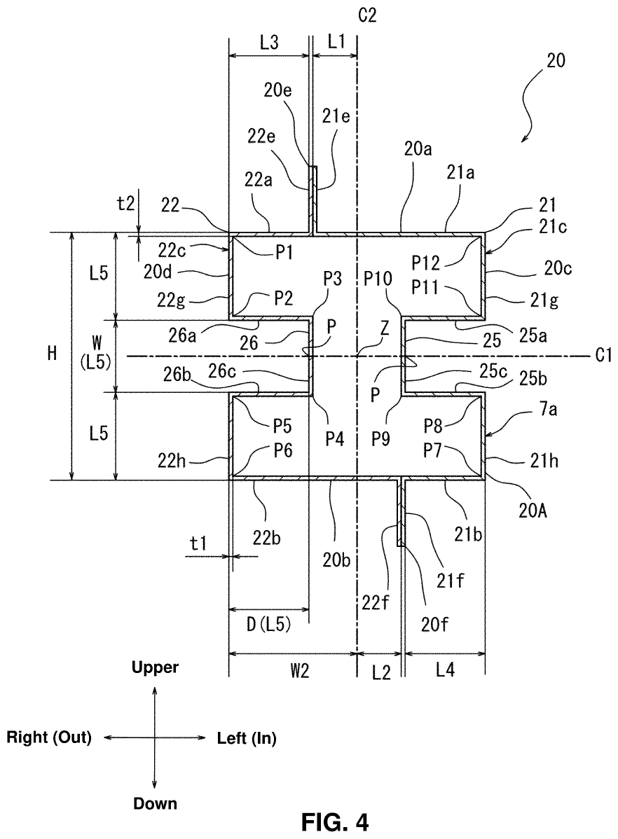

FIG. 3 is a perspective view of the front side frame 20 alone. FIG. 4 is a sectional view schematically showing a cross section (a cross section of a front-side portion 2c of the straight portion 2a of the front side frame 20) taken along line IV-IV of FIG. 3. In the present embodiment, the right-and-left front side frames 20 has substantially a laterally-symmetrical structure. Accordingly, a structure of the right-side front side frame 20 will be described only.

Referring to FIGS. 3 and 4, the front side frame 20 is configured to absorb the collision load by its axial compression when the collision load is applied in the vehicle longitudinal direction. The front side frame 20 is made from iron, aluminum or the like, for example. The front side frame 20 comprises an upper wall portion 20a, a lower wall portion, and a pair of side wall portions 20c, 20d, so that it includes plural vertexes and a frame body portion 20A which has a closed-cross section 7a perpendicular to its extension direction. The front side frame 20 is provided with groove portions 25, 26 which are recessed toward an inside of the closed-cross section 7a at the respective side wall potions 20c, 20d. The groove portions 25, 26 extend in the longitudinal direction. The front side frame 20 has an upper flange 20e and a lower flange 20f, which respectively protrude outward (in the vertical direction in the present embodiment) from the closed-cross section 7a.

As shown in FIG. 4, the front side frame 20 is formed by welding plural sheets of plate member, for example. In the present embodiment, the front side frame 20 comprises an inner panel 21 positioned on the inward side, in the vehicle width direction, thereof and an outer panel 22 positioned on the outward side, in the vehicle width direction, thereof.

The inner panel 21 comprises an inner upper-wall portion 21a extending in the vehicle width direction, an inner lower-wall portion 21b extending in the vehicle width direction, facing the inner upper-wall portion 21a, an inside wall portion 21c interconnecting respective inner ends of the inner upper-wall portion 21a and the inner lower-wall portion 21b, and upper-and-lower flanges 21e, 21f which extend in the vertical direction from respective outer ends of the inner upper-wall portion 21a and the inner lower-wall 21b. Its cross section perpendicular to the extension direction is of a hat shape protruding inward in the vehicle width direction.

The outer panel 22 comprises an outer upper-wall portion 22a extending in the vehicle width direction, an outer lower-wall portion 22b extending in the vehicle width direction, facing the outer upper-wall portion 22a, an outside wall portion 22c interconnecting respective outer ends of the outer upper-wall portion 22a and the outer lower-wall portion 22b, and upper-and-lower flanges 22e, 22f which extend in the vertical direction from respective inner ends of the outer upper-wall portion 22a and the outer lower-wall 22b. Its cross section perpendicular to the extension direction is of another hat shape protruding outward in the vehicle width direction.

The upper flanges 21e, 22e and the lower flanges 21f, 22f of the inner panel 21 and the outer panel 22 are joined together in the vehicle width direction by welding, for example, so that the front side frame 20 with the roughly-rectangular closed-cross section 7a is formed.

The upper wall portion 20a, the lower wall portion 20b, and the pair of side wall portions 20c, 20d of the front side frame 20 are formed by the upper-wall portions 21a, 22a, the lower wall portions 21b, 22b, and the side wall portions 21c, 22c of the inner panel 21 and the outer panel 22. The upper flange 20e and the lower flange 20f of the front side frame 20 are respectively formed by the upper flanges 21e, 22e and the lower flanges 21f, 22f of the inner panel 21 and the outer panel 22.

A projection position of the upper flange 20e relative to the closed-cross section 7a is located on either one side of an outward side and an inward side of center of gravity (figure) Z of the closed-cross section 7a, and a projection position of the lower flange 20f relative to the closed-cross section 7a is located on the other side. In the present embodiment, the upper flange 20e is positioned on the outward side, in the vehicle width direction, of the lower flange 20f. Respective distances L1, L2 of the upper flange 20e and the lower flange 20f, in the vehicle width direction, from the center of gravity Z of the closed-cross section 7a match each other substantially. In this specification, the meaning of the above-described expression: “substantially” includes a tolerance which may be generated unavoidably in manufacturing the inner panel 21 and the outer panel 22.

In this specification, the center of gravity Z of the closed-cross section 7a means an intersection of a straight line C1 which passes through the center, in the vertical direction, between the upper wall portion 20a and the lower wall portion 20b and a straight line C2 which passes through the center, in the vehicle width direction, between the pair of side wall portions 20c, 20d in a cross section of a specified area of the front side frame 20 shown in FIG. 4. In the present embodiment, the specified area is the front-side portion 2c of the straight portion 2a of the front side frame 20.

Groove portions 25, 26, which are recessed toward an inside of the closed-cross section 7a and extend in the vehicle longitudinal direction, are formed at the respective side wall portions 21c, 22c of the inner panel 21 and the outer panel 22.

As shown in FIG. 4, the groove portions 25, 26 are arranged at a facing position, in the vehicle width direction, thereof. In the present embodiment, the width W, in the vertical direction, of each of the groove portions 25, 26 is set at ⅓ of the height H of the closed-cross section 7a. A center P, in the vertical direction, of the width W of the groove portions 25, 26 matches the straight line C1, and the groove portions 25, 26 are located at the center, in the vertical direction, of the closed-cross section 7a.

In the present embodiment, the depth D of the groove portions 25, 26 substantially matches the width W of the groove portions 25, 26. The depth D of the groove portions 25, 26 is set to be smaller than the distance W2, in the vehicle width direction, between the side wall portions 20c, 20d and the center of gravity Z. The groove portions 25, 26 are positioned on the outward side of the straight line C2 which extends in the vertical direction, passing through the center of gravity D. The depth D of the groove portions 25, 26 substantially matches the width L3, L4 of the outer upper-wall portion 22a and the inner lower-wall portion 21b.

The groove portions 25, 26 comprise groove-upper wall portions 25a, 26a which are located at an upper side and extend in the vehicle width direction at the closed-cross section 7a, groove-lower wall portions 25b, 26b which are located at a lower side and extend in the vehicle width direction, facing the groove-upper wall portions 25a, 26a, and groove-bottom wall portions 25c, 26c which interconnect respective inner ends of the groove-upper wall portions 25a, 26a and the groove-lower wall portions 25b, 26b in the vertical direction.

Referring to FIG. 4, the side wall portion 21c of the inner panel 21 and the side wall portion 22c of the outer panel 22 are configured to have substantially the same bending rigidity. Specifically, the respective side wall portions 21c, 22c of the inner panel 21 and the outer panel 22 are made of plural side wall portions having substantially the same bending rigidity, so that the respective bending rigidities of the above-described plural side wall portions are substantially the same. In the present embodiment, the above-described bending rigidity means the one for a direction perpendicular to each face of the respective side wall portions (i.e., a thickness direction of each of the side wall portions).

The plural side wall portions comprise upper side wall portions 21g, 22g located above the respective groove portions 25, 26, lower side wall portions 21h, 22h located below the groove portions 25, 26, groove-upper wall portions 25a, 26a, groove-lower wall portions 25b, 26b, and groove-bottom wall portions 25c, 26c, which are provided at the respective side wall portions 21c, 22c of the inner panel 21 and the outer panel 22. The plural side wall portions are configured to have substantially the same plate thickness t1 and substantially the same side length L5 of the closed-cross section 7a. Further, the respective upper-wall portions 22a, 21a of the inner panel 21 and the outer panel 22 are configured to have substantially the same plate thickness t2 and substantially the same side lengths L4, L3 as those of the respective side wall portions.

As shown in FIG. 4, the closed-cross section 7a has plural vertexes P1-P12 (first-twelfth vertexes). The first vertex P1 is an intersection of the outer upper-wall portion 22a and the upper side wall portion 22g. The second vertex P2 is an intersection of the upper side wall portion 22g and the groove-upper wall portion 26a. The third vertex P3 is an intersection of the groove-upper wall portion 26a and the groove-bottom wall portion 26c. The fourth vertex P4 is an intersection of the groove-bottom wall portion 26c and the groove-lower wall portion 26b. The fight vertex P5 is an intersection of the groove-lower wall portion 26b and the lower side wall portion 22h. The sixth vertex P6 is an intersection of the lower side wall portion 22h and the outer lower wall portion 22b. The seventh vertex P7 is an intersection of the inner lower-wall portion 21b and the lower side wall portion 21h. The eighth vertex P8 is an intersection of the lower side wall portion 21h and the groove-lower wall portion 25b. The sixth vertex P9 is an intersection of the groove-lower wall portion 25b and the groove-bottom wall portion 25c. The tenth vertex P10 is an intersection of the groove-bottom wall portion 25c and the groove-upper wall portion 25a. The eleventh vertex P11 is an intersection of the groove-upper wall portion 25a and the upper side wall portion 21g. The twelfth vertex P12 is an intersection of the upper side wall portion 21g and the inner upper-wall portion 21a.

The closed-cross section 7a is symmetrical about a point of its center of gravity Z, including protrusion positions of the upper-and-lower flanges 20e, 20f and unsymmetrical about all lines which pass through the center of gravity Z and are perpendicular to the longitudinal direction. The above-described expression: “be symmetrical about a point of its center of gravity Z” means that in a case where the closed-cross section 7a is rotated by 180 degrees around the center of gravity Z, the first-sixth vertexes P1-P6 and the protrusion position of the upper flange 20e substantially matches the seventh-twelfth vertexes P7-P12 and the protrusion position of the lower flange 20f, respectively.

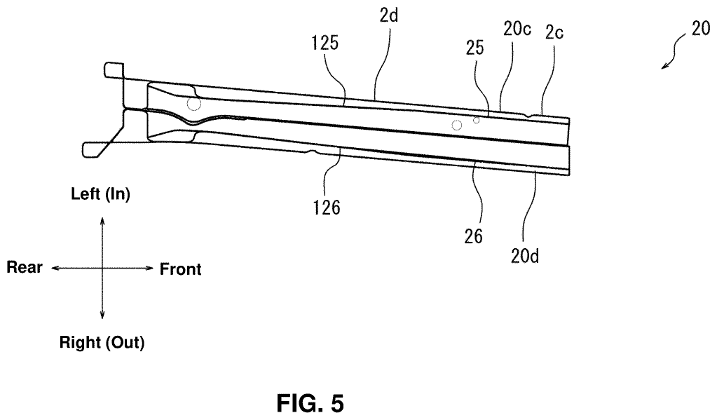

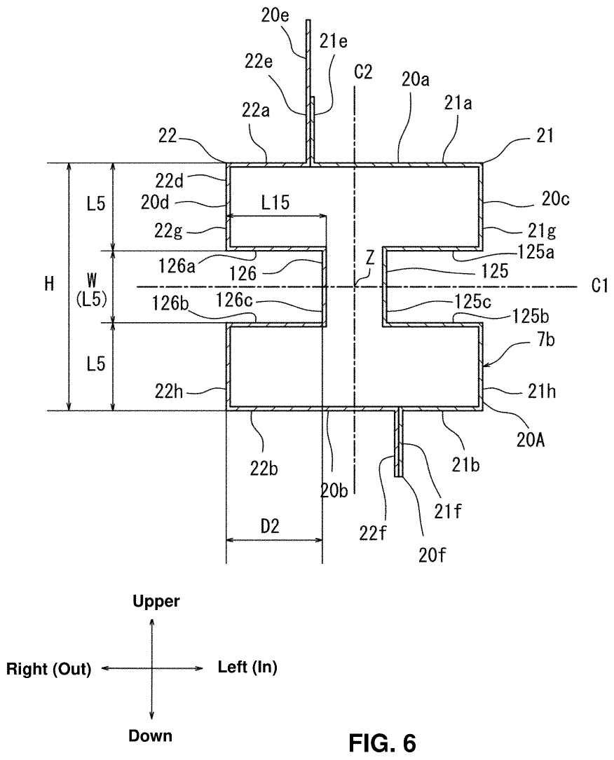

Referring to FIGS. 5 and 6, the depth of the groove portions 25, 26 are configured such that that of the rear-side groove portions is deeper than that of the front-side groove portions. More specifically, the depth D2 of groove portions 125, 126 of a closed-cross section 7b which is positioned at a rear-side portion 2d of the front side frame 20 shown in FIG. 6 is deeper than that of the groove portions 25, 26 of the closed-cross section 7a which is positioned at the front-side portion 2c of the front side frame 20 shown in FIG. 4. The side length L15 of groove-upper wall portions 125a, 126a of the closed-cross section 7b is longer than the side length L15 of groove-bottom wall portions 125c, 126c, the upper side wall portions 21g, 22g, and the lower side wall portion 21h, 22h of the closed-cross section 7b.

As shown in FIGS. 3, 4 and 5, the upper flange 20e of the rear-side portion 2d of the front side frame 20 protrudes upward from the upper flange 20e of the front-side portion 2c. More specifically, the upper flange 22e of the outer panel 22 is configured such that the rear-side portion 2d is longer than the front-side portion 2c.

Herein, in the present embodiment, as shown in FIG. 2, the front-side portion 2c of the front side frame 20 is a portion of the straight portion 2a which is positioned on the forward side of the suspension housing 40, and the rear-side portion 2d is another portion of the straight portion 2a where the suspension housing 40 is attached.

As shown in FIGS. 1, 2 and 7, the suspension housing 40 is attached to the front side frame 20. The suspension housing 40 supports an upper end of a front suspension (not illustrated) which is arranged at an appropriate position located in front of the dash panel 10. The suspension housing 40 is provided to extend between the apron reinforcement 30 and the front side frame 20.

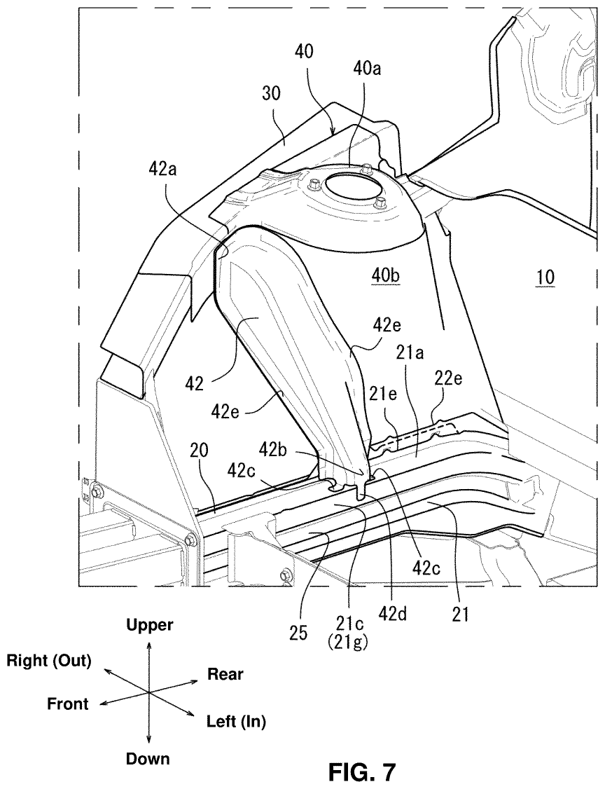

As shown in FIG. 7, the suspension housing 40 is a roughly-cone shaped cylindrical member with a disc-shaped upper face. The suspension housing 40 comprises a roughly disc-shaped suspension-top support portion 40a to support the suspension and a tower portion 40b which expands downward from the suspension-top support portion 40a. The suspension-top support portion 40a is fixed to an upper face portion of the apron reinforcement 30 by welding or the like.

The tower portion 40b is configured to extend downward from an outside end portion, in a radial direction, of the suspension-top support portion 40a. An upper end portion of the tower portion 40b is fixed to a lower end portion of the suspension support portion 40a and an inside face of the apron reinforcement 30 by welding or the like. A lower end portion of the tower portion 40b is fixed to the upper flange 22e of the outer panel 22 of the front side frame 20 by welding or the like in a state where it overlaps the upper flange 22e from the outward side, in the vehicle width direction, thereof.

The suspension housing 40, which has a roughly hat-shaped cross section open to the outward side, in the vehicle width direction, thereof, is arranged adjacently to a front side of the tower portion 40b, and has a first reinforcing member 42 extending in the vertical direction. An upper end portion 42a of the first reinforcing member 42 is joined to the front side portion of the tower portion 40b which is fixed to an inside face of the apron reinforcement 30 by welding or the like. A lower end portion 42b of the first reinforcing member 42 is fixed to the inner upper-wall portion 21a and the inner side-wall portion 21c of the inner panel 21 by welding or the like. The lower end portion 42b of the first reinforcing member 42 is provided with an upper-face fixation potion 42c which is fixed to the inner upper-wall portion 21a and a side-face fixation portion 42d which is fixed to the inner side-wall portion 21c. A pair of flange portions 42e of the first reinforcing member 42 which extend in the longitudinal direction are joined to a front face side of the tower portion 40b by welding or the like.

As shown in FIG. 2, the suspension housing 40 comprises a second reinforcing member 43 which is arranged on the outward side, in the vehicle width direction, of the tower portion 40b. The second reinforcing member 43 is of a roughly hat shape and extends in the vertical direction. A pair of flange portions 43a of the second reinforcing member 43 which extend in the longitudinal direction are joined to the tower portion 40b from the outward side, in the vehicle width direction, thereof by welding or the like. The pair of flange portions 43a are joined to the upper flange 22e of the outer panel 22 by welding or the like at a lower end portion 43b of the second reinforcing member 43. At the lower end portion 43b of the second reinforcing member 43 is provided a side-face fixation portion 43c which is joined to the outer side-wall portion 22c by welding or the like.

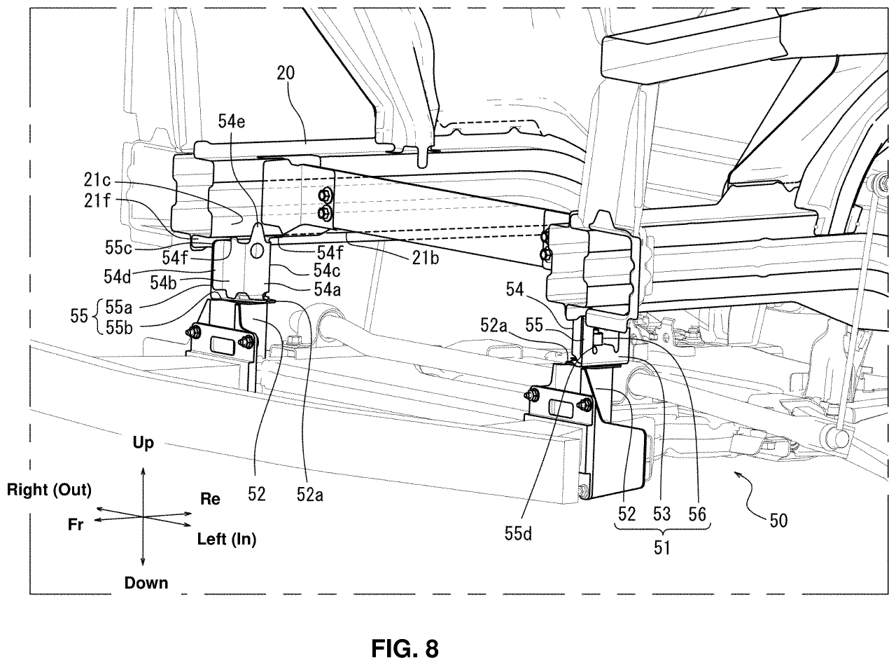

As shown in FIGS. 2 and 8, the subframe 50 and the front side frame 20 are connected by the connecting member 51. The connecting member 51 comprises a lower-side connecting member 52 which is positioned below that and connected to the subframe 50, an upper-side connecting member 53 which is positioned above that and connected to the front side frame 20, and a fastening member 56 which fastens the lower-side connecting member 52 and the upper-side connecting member 53.

The lower-side connecting member 52 has a roughly U-shaped cross section open to the forward side and extends in the vertical direction. The lower-side connecting member 52 is fixed to the subframe 50 by welding or the like at its lower end portion. A plate member 52a to arrange a fastening member 54 is joined to an upper end portion of the lower-side connecting member 52.

The upper-side connecting member 53 comprises a pole member 54 which has a roughly U-shaped cross section open to the outward side, in the vehicle width direction, thereof and an L-shaped plate member 55 which covers an outward-and-lower side of the pole member 54.

The pole member 54 comprises an inner wall 54a which extends in the vertical direction, a front wall 54b and a rear wall 54c which extend outward, the width direction, thereof from a front edge and a rear edge of the inner wall 54a, and a pair of front-and-rear flanges 54d which respectively extend forward and rearward from the front wall 54b and an outer edge of the rear wall 54c.

The plate member 55 includes a vertical wall 55a extending in the vertical direction and a bottom wall 55b extending inward in the vehicle width direction, thereof from a lower end of the vertical wall 55a. The upper-side connecting member 53 is formed in a hollow-box shape by the pair of flange portions 54d of the pole member 54 and the vertical wall 55a of the plate member 55 which are joined together in the width direction by welding or the like.

At the pole member 54 are provided a side-face fixation portion 54e which extends upward from the inner wall 54a and is fixed to the side wall portion 21c of the inner panel 21 and a lower-face fixation portion 54f which respectively extend forward and rearward from the front wall 54b and an upper edge of the rear wall 54c and is fixed to the lower wall portion 21b of the inner panel 21. The plate member 55 is joined to the lower flange 21f of the inner panel 21 at the upper end portion 55c by welding or the like.

The fastening member 56 is a weld nut and a bolt or the like which are fixed to a tongue-side portion 55d. The tongue-side portion 55d is made of part of a vertical wall of the plate member 55 which has been cut off and bent inward, in the vehicle width direction, thereof. The upper-side connecting member 51 and the lower-side connecting member 52 are joined together by inserting the bolt from a position below the plate member 52 and screwing the bolt into the weld nut.

The effects of the frame member 20 for the vehicle according to the above-described embodiment will be described.

The front side member 20 extending in the longitudinal direction comprises the frame body portion 20A having the closed-cross section 7a perpendicular to the extension direction, the closed-cross section 7a having the plural vertexes P1-P12, a pair of groove portions 25, 26 formed at a pair of side wall portions 20c, 20d which form the closed-cross section 7a of the frame body portion 20A, the groove portions 25, 26 being recessed toward the inside of the closed-cross section 7a, and the plural flanges 20e, 20f protruding outward from the closed-cross section 7a, wherein the closed-cross section 7a is symmetrical about the point of center of gravity Z of the closed-cross section 7a, including the projection positions of the plural flanges 20e, 20f, and is nonsymmetrical about all straight lines which pass through the center of gravity Z of the closed-cross section 7a and are perpendicular to the longitudinal direction.

According to the present embodiment, since the closed-cross section 7a of the front side frame 20 is symmetrical about the point of center of gravity Z of the closed-cross section 7a, including protrusion positions of the flanges 20e, 20f, even in a case where the projection positions of the flanges 20e, 20f are located unevenly in the vehicle width direction, a difference, in the vehicle width direction, of the buckling resistance of the front side frame 20 against the load applied in the longitudinal direction can be suppressed. Consequently, when the collision load is applied, the front side frame 20 can be axially-compressed stably, thereby absorbing the collision load expectedly. Further, compared to a case where no groove portion is provided, the moment of inertia (of area) of the front side frame 20 is made so large that the buckling resistance can be properly large. Accordingly, by configuring the front side frame 20 such that the closed-cross section 7a, including the groove portions 25, 26, is symmetrical about the point of center of gravity Z of the closed-cross section 7a, both an increase of the buckling resistance and a stable axial compression can be attained for the front side frame 20.

The frame member for the vehicle is a pair of front side frames 20 positioned on the both-side portions, in the vehicle width direction, of the engine room E.

According to this structure, when the collision load is applied from the vehicle forward side, the front side frame 20 can be stably axially-compressed.

The groove portions 25, 26 are provided to face each other in the vehicle width direction.

According to this structure, compared to a case where the vertical positions of the groove portions 25, 26 are different from each other, the difference, in the vertical direction, of the bending rigidity of the front side frame 20 is so suppressed that the front side frame 20 can be axially-compressed uniformly.

The groove portions 25, 26 comprise the groove-upper wall portions 25a, 26a extending inward at their upper sides, the groove-lower wall portions 25b, 26b extending inward at their lower sides and facing the groove-upper wall portions 25a, 26a, and the groove-bottom wall portions 25c, 26c interconnecting the respective inner ends of the groove-upper wall portions 25a, 26a and the groove-lower wall portions 25b, 26b in the vertical direction, and the groove-upper wall portions 25a, 26a, the groove-lower wall portions 25b, 26b, and the groove-bottom wall portions 25c, 26c are configured to have the same side length of the closed-cross section 7a.

According to this structure, compared to a case where the respective groove-wall portions 25a, 26a, 25b, 26b, 25c, 26c of the groove portions 25, 26 have the different side length, the difference of the bending rigidity among the respective groove-wall portions 25a, 26a, 25b, 26b, 25c, 26c of the groove portions 25, 26 is so suppressed that the front side frame 20 can be axially-compressed stably.

The groove portions 25, 26 are configured such that their vehicle rearward-located portions are deeper than their vehicle forward-located portions.

According to this structure, the rear-side portion (vehicle rearward-located portion) 2d of the front side frame 20 has the higher rigidity than the front-side portion (vehicle forward-located portion) 2c. Accordingly, the front-side portion 2c can absorb the collision load through its deformation when receiving the collision load applied from the vehicle forward side, and also can receive the collision load properly at the rear-side portion 2d having the high rigidity in order to secure the performance of the collision-load absorption by means of the front-side portion 2d.

Herein, the present invention is not limited to the above-described embodiment and any modifications are applicable.

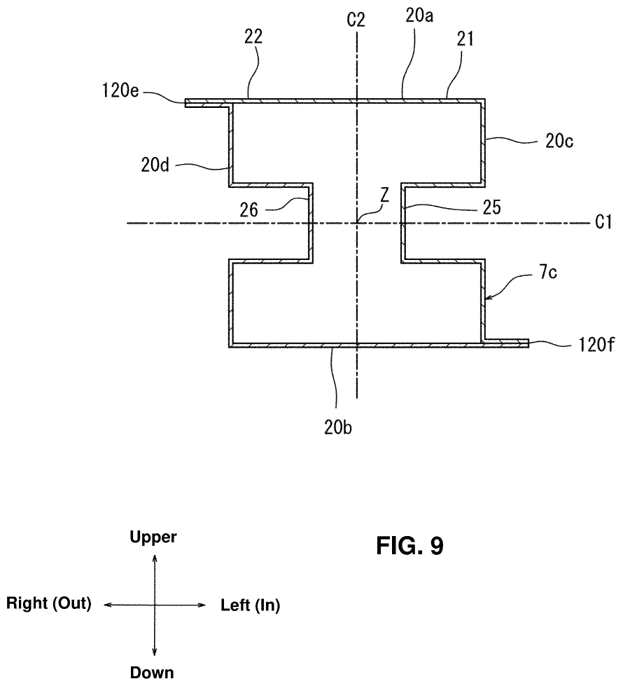

While the above-described embodiment is configured such that the flanges 20e, 20f extend in the vertical direction from the closed-cross section 7a, the present invention is not limited to this. The flanges 120e, 120f may extend in the width direction from the closed-cross section 7c as shown in FIG. 9, for example.

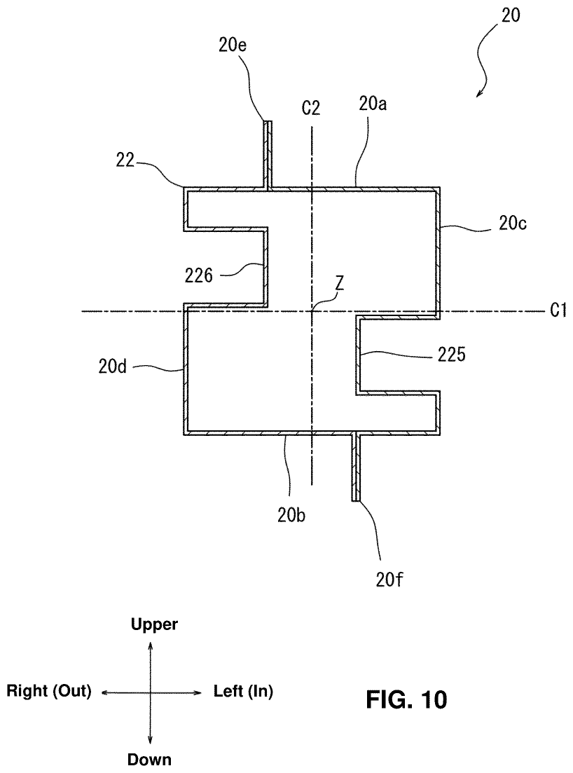

Further, while the longitudinal positions of the groove portions 25, 26 match each other in the present embodiment, the present invention is not limited to this as long as the groove portions 25, 26 are symmetrical about the point of the center of gravity Z. For example, as shown in FIG. 10, the vertical positions of the groove portions 225, 226 may be offset from each other.

Moreover, the above-described shows the structure in which the frame member comprises the inner panel 21 and the outer panel 22, this frame member may be an extruded aluminum member or the like.

### ADDITIONAL NOTES

The present invention includes the following aspects.

### First Aspect

The frame member for the vehicle which extends in the longitudinal direction, comprising the frame body portion having the closed-cross section perpendicular to the extension direction thereof, the closed-cross section having plural vertexes, a pair of groove portions formed at a pair of side wall portions which form the closed-cross section of the frame body portion, the groove portions being recessed toward the inside of the closed-cross section, and plural flanges protruding outward from the closed-cross section, wherein the closed-cross section is symmetrical about the point of center of gravity of the closed-cross section, including projection positions of the plural flanges, and is nonsymmetrical about all straight lines which pass through said center of gravity of the closed-cross section and are perpendicular to the longitudinal direction.

### Second Aspect

The frame member for the vehicle of the first aspect, wherein the frame member for the vehicle is a pair of front side frames positioned on the both-side portions, in the vehicle width direction, of the engine room.

### Third Aspect

The frame member for the vehicle of the first or second aspects, wherein the groove portions are provided to face each other in the vehicle width direction.

### Fourth Aspect

The frame member for the vehicle of the first or second aspects, wherein each of the groove portions comprises the groove-upper wall portion extending inward at the upper side thereof, the groove-lower wall portion extending inward at the lower side thereof and facing the groove-upper wall portion, and the groove-bottom wall portion interconnecting the respective inner ends of the groove-upper wall portion and the groove-lower wall portion in the vertical direction, and the groove-upper wall portion, the groove-lower wall portion, and the groove-bottom wall portion are configured to have the same side length of the closed-cross section.

### Fifth Aspect

The frame member for the vehicle of the first or second aspects, wherein the groove portion is configured such that the vehicle rearward-located portion thereof is deeper than the vehicle forward-located portion thereof.

What is claimed is:

1. A frame member for a vehicle which extends in a longitudinal direction, comprising:
a frame body portion having a closed-cross section perpendicular to an extension direction thereof, the closed-cross section having plural vertexes;
a pair of groove portions formed at a pair of side wall portions which form the closed-cross section of the frame body portion, the groove portions being recessed toward an inside of the closed-cross section; and
plural flanges protruding outward from the closed-cross section,
wherein said closed-cross section is symmetrical about a point of center of gravity of said closed-cross section, including projection positions of said plural flanges, and is nonsymmetrical about all straight lines which pass through said center of gravity of the closed-cross section and are perpendicular to the longitudinal direction.

2. The frame member for the vehicle of claim 1, wherein said frame member for the vehicle is a pair of front side frames positioned on both-side portions, in the vehicle width direction, of an engine room.

3. The frame member for the vehicle of claim 1, wherein said groove portions are provided to face each other in the vehicle width direction.

4. The frame member for the vehicle of claim 1, wherein each of said groove portions comprises a groove-upper wall portion extending inward at an upper side thereof, a groove-lower wall portion extending inward at a lower side thereof and facing said groove-upper wall portion, and a groove-bottom wall portion interconnecting respective inner ends of said groove-upper wall portion and said groove-lower wall portion in a vertical direction, and said groove-upper wall portion, said groove-lower wall portion, and said groove-bottom wall portion are configured to have the same side length of said closed-cross section.

5. The frame member for the vehicle of claim 1, wherein said groove portion is configured such that a vehicle rearward-located portion thereof is deeper than a vehicle forward-located portion thereof.

6. The frame member for the vehicle of claim 2, wherein said groove portions are provided to face each other in the vehicle width direction.

7. The frame member for the vehicle of claim 2, wherein each of said groove portions comprises a groove-upper wall portion extending inward at an upper side thereof, a groove-lower wall portion extending inward at a lower side thereof and facing said groove-upper wall portion, and a groove-bottom wall portion interconnecting respective inner ends of said groove-upper wall portion and said groove-lower wall portion in a vertical direction, and said groove-upper wall portion, said groove-lower wall portion, and said groove-bottom wall portion are configured to have the same side length of said closed-cross section.

8. The frame member for the vehicle of claim 2, wherein said groove portion is configured such that a vehicle rearward-located portion thereof is deeper than a vehicle forward-located portion thereof.
